(19) United States
(12) Patent Application Publication
(10) Pub. No.: US 2005/0151427 A1
(43) Pub. Date: Jul. 14, 2005

(54) Digital video signal switching device

(76) Inventor: Kuo-Tsai Chiou, Hsin Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/753,466

(22) Filed: Jan. 9, 2004

(51) Int. Cl. H02J 1/00

(52) U.S. Cl. 307/43

(57) ABSTRACT

The present invention is related to a video switching device, which comprises a digital imaging processing means, a digital image connecting means and a digital image display means to offer a high quality and resolution image.

### BACKGROUND OF THE INVENTION

The present invention relates to a kind of digital video signal switching device, especially for displaying a high-resolution image on a digital image display means.

With the popularization of the cable television (CATV) network or internet network, image signals transmitting by the CATV or internet proprietary can be decoded and displayed on a known image display means by a video switching device (SET TOP BOX, STB), such as televisions and monitors, generally in the family. A known video switching device is composed of a front-end processing chip, a terminal processing chip, an image processing means, a RF-circuit and a corresponding connecting means, where the said front-end processing chip relates to a system on a chip (SOC) of an Analog-to-Digital (A/D) converter, demodulation and Forward Error Correction (FEC), and the said terminal processing chip relates to a SOC of broadcast/micro-processing, a Video/Audio decoder and a video encoder with a D/A part. The received video signals is processed by the said image processing means and then transmitted by a corresponding set of S-video connectors to a known image displaying means or a monitoring device, on which the processed video signals is displayed; or the received signals can be data-exporting processed by the said RF circuit and then the processed video signals is transmitted by a corresponding RF terminal to a wireless access point.

Because the CATV/internet network which has a larger bandwidth can rapidly and completely transmit video signals of larger capacity, and offer several video channels for the consumers simultaneously, to meet demands for the quality while consumers watching and for multiple selecting of channels. In addition, techniques of all sorts related to high resolution image displaying are generally revealed and applied, and with the ripeness for miscellaneous digital techniques and the popularization of high-resolution displayers with varied sizes; it has become the basic demand to have a high resolution image while people watching.

The existed video switching device (SET TOP BOX, STB) transmit the output signals in a format of linear signals by a image processing means or a RF circuit to a known image displaying means, however, for the disadvantage of low resolution of the linear signals, the quality of images displaying by the known displaying means can not be improved to a high quality of resolution to meet the demands of consumers; or for the difference between the interface of adapters, the video signals can not be connected by the existed video switching device and displayed on a high resolution image displaying device or a high resolution monitoring device. Therefore, a great effort has to be done to meet the demands for a high resolution image displaying.

### SUMMARY OF THE INVENTION

The present invention is related to a video switching device; the main objective is to offer a converting means, which can be connected and displaying on a high-resolution displayer, to provide a high-resolution image for consumers; and the second objective is to offer a selection for users while modifying the connecting interface by the functional compatibility with the existed video switching device.

The present invention is related to a video switching device, which comprises leastwise a front-end processing chip, a terminal processing chip, a digital image processing means, and a digital image connecting means, wherein the said front-end processing chip relates to a system on a chip (SOC) of an Analog-to-Digital (A/D) converter, demodulation and Forward Error Correction (FEC); the said terminal processing chip relates to a SOC of rebroadcasting/micro-processing, a Video/Audio decoder and a video encoder with a D/A part; the said digital image processing means is used to process and transfer the received video signals to digital exporting signals and the signals is connecting by the said digital visual interface (DVI) connector and then displayed by a high-resolution displaying means or a monitoring device, wherein the digital visual image processing means is composed by Silicon Image IC Si1164 or other integrated circuits with the same electrical working properties.

In order to make the persons who are familiar to this technique understand the objective, characteristics, and functions of the present invention, the invention is illustrated in detail by the embodiments and the assorting figures as follows.

### BRIEF DESCRIPTION OF THE DRAWINGS

FIG. 1 is a block diagram for a known video switching device;

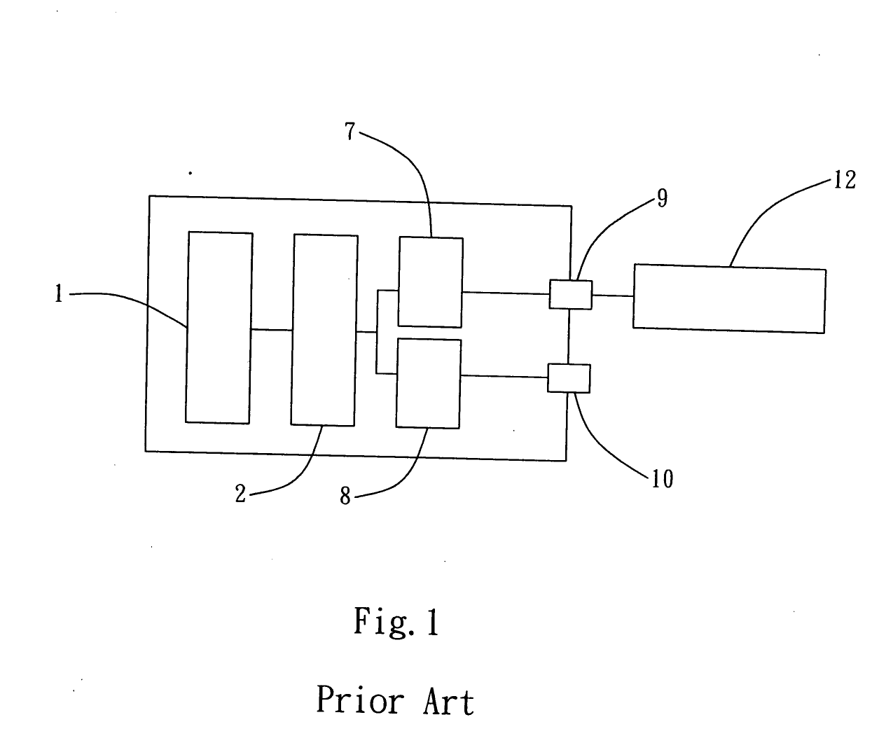

FIG. 2 is a block diagram for an application method of the present invented video switching device;

FIG. 3 is a block diagram for another application method of the present invented video switching device;

FIG. 4 is a block diagram for still another application method of the present invented video switching device.

### DETAILED DESCRIPTION OF THE PREFERRED EMBODIMENT

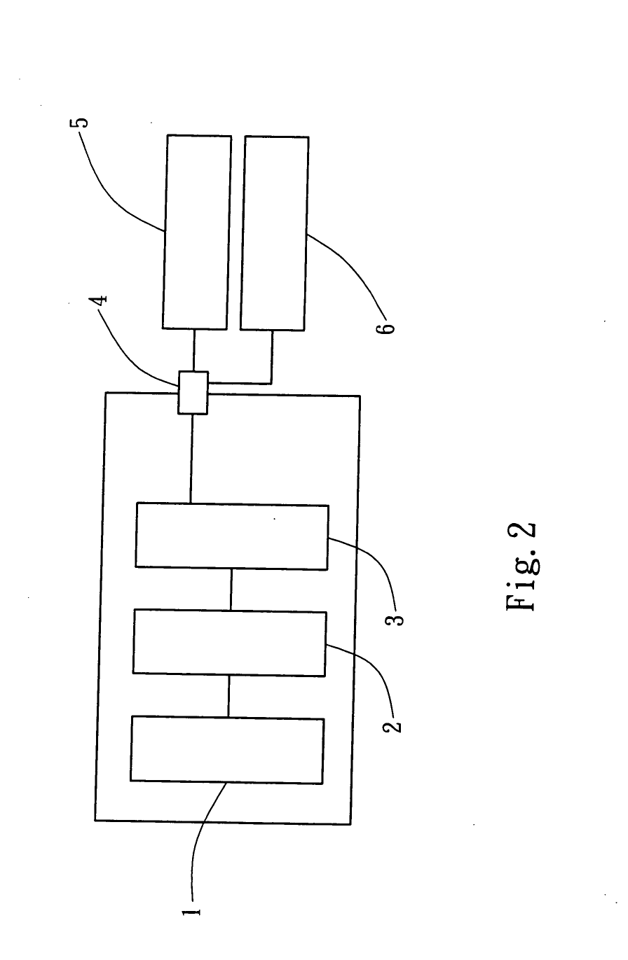

Referring to FIG. 2, which is a typical diagram of the present invention, the said video switching device, which comprises leastwise a front-end processing chip 1, a terminal processing chip 2, a digital image processing means 3, a digital image connecting means 4, and a high-resolution image displaying means 5, or a high-resolution monitoring means 6, wherein the component 1 relates to a front-end processing chip, which is used to process A/D, to demodulate, and to function as FEC, and is connected with the component 2, which is the terminal processing chip; the component 2 is related to a terminal processing chip to function as broadcast, the Video/Audio decoder, a Video Encoder with the D/A part, and transmit the processed signals to a digital image processing means 3 by an appropriate transmitting passage, to switch and export the processed video signals into a digital displaying type; the component 3 is connected with a digital displaying means 5 by a digital image connecting means and display the related video signals on the high-resolution image displaying means 5 or a high-resolution monitoring device 6, to provide the consumers a most legible digital displaying image.

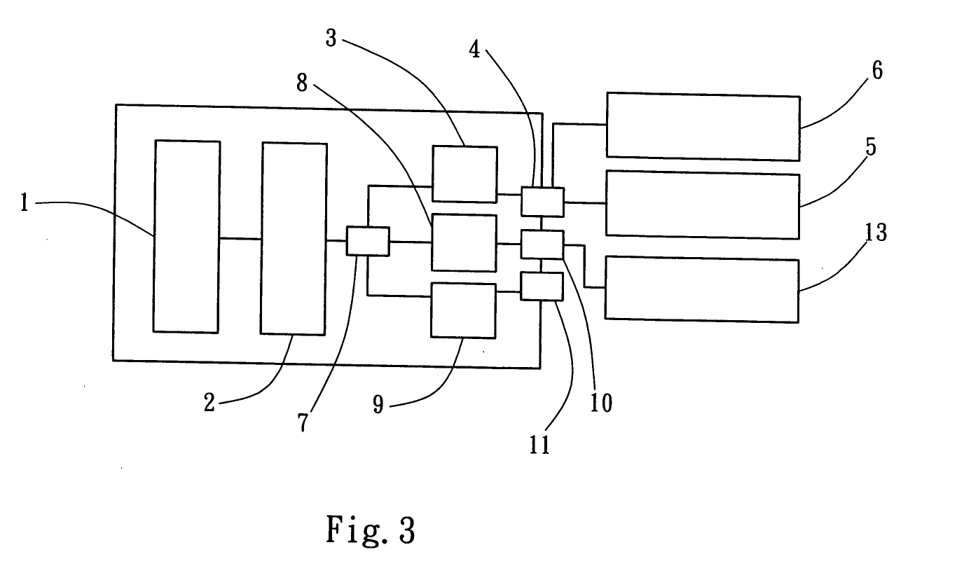

Referring to FIG. 3, which is another embodiment for the present invention. The said video switching device comprises leastwise a front-end processing chip 1, a terminal processing chip 2, a digital image processing device 3, and a digital image-connecting device 4; wherein the component 1 relates to a front-end chip, which functions as A/D processing, demodulation, and Forward Error Correction (FEC), and connects with the component 2, which is the terminal processing chip; the component 2 is related to a terminal processing chip to function as broadcast, the Video/Audio decoder, a Video Encoder with the D/A part, and transmit the processed signals to a digital image processing means 3 by an appropriate transmitting passage, to switch and export the processed video signals into a digital displaying type; the component 3 is connected with a digital displaying means 5 or a high-resolution monitoring device 6 by a digital image connecting means and display the related video signals on the high-resolution image displaying means 5 or a high-resolution monitoring device 6; furthermore, the output port can comprise an image processing means 8, a RF circuit 9, and a corresponding connecting port, a S-video output port 10 and a RF output port 11, which is related to connect leastwise with a known image displaying means 13. The video signals is processed by the said image processing means 8 or the RF circuit 9, and then connected with and displayed on a known image displaying means 13 by the corresponding S-video output port 10 or the RF output port 11.

In addition, the said video switching device comprises a detecting unit 7 furthermore, which is used to detect the specification of the displaying means connected to the out port, to determine the type of output signals, and, the said detecting unit 7 can be a single independent unit or a single function of the terminal processing united chip 2.

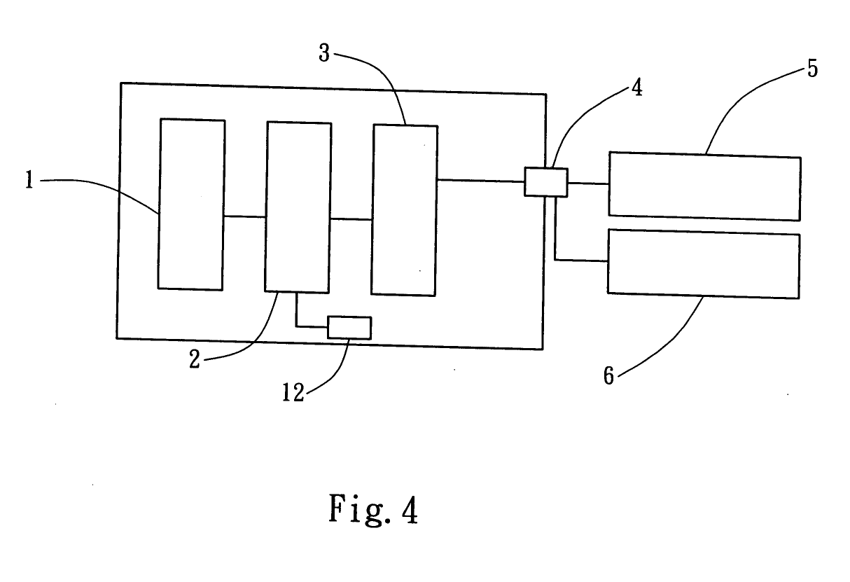

Referring to FIG. 4, which is another embodiment for the present invention. The said video switching device comprises leastwise a front-end processing chip 1, a terminal processing chip 2, a digital image processing device 3, and a digital image-connecting device 4; wherein the component 1 relates to a front-end chip, which functions as A/D processing, demodulation, and Forward Error Correction (FEC), and connects with the component 2, which is the terminal processing chip; the component 2 is related to a terminal processing chip to function as broadcast, the Video/Audio decoder, a Video Encoder with the D/A part, and transmit the processed signals to a digital imaging processing device 3 by an appropriate transmitting passage, to switch and export the processed video signals into a digital displaying type; the component 3 is connected with a digital displaying device 5 by a digital image connecting means and display the related video signals on the said high-resolution image displaying means; wherein the said video switching comprises leastwise a connecting port 12, which connecting port 12 can be a game controlling port to offer the connection with a game controlling device, to provide the consumers playing games on the said video switching device. The said connecting port can be a computer video transferring port, which relates to offer a connection of a computer and the said video switching device, to display the processed data by the computer on the displaying means connecting with the said video switching device.

Additionally, the said video switching device can be in a type of single device and connect with a CATV or internet network, and can connect to a displaying means by a high speed interface; wherein the high speed interface can be a universal serial bus (USB) or IEEE 1394; furthermore, the said video switching device can be connected to a computer in type of CardBus by an appropriate passage; the said passage can be connecting by a PCI interface, which can offer a working voltage by the computer for the video switching device, and offer a switching way to display the computer image on the displaying means connecting to the video switching device.

It can be understood from the above description that the video switching device of the present invention can not only coexist with the existed video switching device, but also connect with a high-resolution displaying means or a high-resolution monitoring device by an additional digital image processing means or a digital image connecting means, to offer a more legible image for the consumer; and, comparing to the existed ones, the video switching device of the present invention has a lager advancement and freshness in compatibility with the displaying means and has worthiness in application for the permeation maturity of the relative techniques of the high-resolution image displaying means.

A detail illustration for the present invention is revealed, however, the above description is just a better embodiment of the present invention, which is not the restriction while applying. That is, all of the equal variation and modification from the claims of the present invention is in range of the present invention pattern.

1. A video switching device comprising:
a front-end processing chip transferring from analog to digital and demodulating Forward Error Connection (FEC);
a terminal processing chip being connected to the front-end processing chip for processing broadcast and transferring from digital to analog;
a digital image processing device being connected to the terminal processing chip for transferring received output image signals to digital output signals and demonstrating the digital output signals on a digital displaying device;
a digital image connecting means being an interface of demonstrating the digital output signals on a digital displaying device.

2. The video switching device of claim 1, wherein the digital image connecting means is a DVI connecting means.

3. The video switching device of claim 1, wherein the digital image processing device is a Silicon Image IC Si1164.

4. The video switching device of claim 1, wherein the video switching device further comprises an image processing means, a RF circuit, a set of S-video output terminals correspondingly and a RF output terminal connecting to at least one displaying device.

5. The video switching device of claim 4, wherein the video switching device further comprises a connecting detecting unit to detect specifications of the displaying device for determining a formation of the output signals.

6. The video switching device of claim 5, wherein the connecting detecting unit is one of the followings: a single and independent connecting component and a single function of the terminal processing united chips.

7. The video switching device of claim 1, wherein the video switching device further comprises at least one connecting port.

8. The video switching device of claim 7, wherein the connecting port is a game-controlling port.

9. The video switching device of claim 1, wherein the video switching device is one of the following: a mono-structure and a pinning groove.

10. The video switching device of claim 9, wherein connection between the video switching device and the digital displaying device is one of the following: a Universal Serial Bus (USB) and IEEE 1394.

11. The video switching device of claim 1, wherein the video switching device is connected to a computer by a pin fillister and a connecting channel.

12. The video switching device of claim 11, wherein the connecting channel is one of the following: a PCI interface and a Mini-PCI interface.
